(19) United States
(12) Patent Application Publication
(10) Pub. No.: US 2018/0302455 A1
(43) Pub. Date: Oct. 18, 2018

(54) SYSTEMS AND METHODS FOR ADJUSTING VIDEO TRANSMISSION BITRATES

(71) Applicant: Facebook, Inc., Menlo Park, CA (US)

(72) Inventor: Udeepta Dutta Bordoloi, Foster City, CA (US)

(21) Appl. No.: 15/490,340

(22) Filed: Apr. 18, 2017

(51) Int. Cl. H04L 29/06; H04N 21/2662; H04N 21/2187

(52) U.S. Cl. CPC H04L 65/607; H04L 65/80; H04N 21/2187; H04N 21/2662; H04L 65/601

(57) ABSTRACT

Systems, methods, and non-transitory computer-readable media can receive a first set of motion metrics indicative of a degree of movement of a computing device during capture of a first portion of a content stream. A first bitrate is determined based on the first set of motion metrics. The content stream is encoded using the first bitrate.

### FIELD OF THE INVENTION

The present technology relates to the field of media content processing. More particularly, the present technology relates to systems and methods for encoding broadcasts.

### BACKGROUND

Today, people often utilize computing devices (or systems) for a wide variety of purposes. Users can use their computing devices, for example, to interact with one another, create content, share content, and view content. For example, users can stream content through their computing devices. In general, content can be streamed from a broadcasting user's computing device, which uploads encoded data (e.g., audio, video, or both). The encoded data then can be downloaded, decoded, and presented on a viewing user's computing device.

### SUMMARY

Various embodiments of the present disclosure can include systems, methods, and non-transitory computer readable media configured to receive a first set of motion metrics indicative of a degree of movement of a computing device during capture of a first portion of a content stream. A first bitrate is determined based on the first set of motion metrics. The content stream is encoded using the first bitrate.

In an embodiment, the first set of motion metrics comprise at least one of: device speed, device velocity, device acceleration, device angular speed, device angular velocity, device angular acceleration, or device distance traveled.

In an embodiment, at least a portion of the first set of motion metrics is measured by a gyroscope in the computing device.

In an embodiment, the first bitrate is selected from a range of possible bitrates, including a minimum bitrate and a maximum bitrate.

In an embodiment, the first set of motion metrics is converted into a first movement score. The first bitrate is determined based on the first movement score.

In an embodiment, each motion score of a set of potential motion scores corresponds to a bitrate of the range of possible bitrates.

In an embodiment, motion scores at or below a lower motion score threshold correspond to the minimum bitrate, and motion scores at or above an upper motion score threshold correspond to the maximum bitrate.

In an embodiment, the encoded first portion is transmitted to a content provider. A bitrate recommendation is received from the content provider. A second bitrate is determined based on the bitrate recommendation, and the content stream is encoded using the second bitrate.

In an embodiment, a second set of motion metrics indicative of a degree of movement of the computing device during capture of a second portion of the content stream is received. A second bitrate is determined based on the second set of motion metrics, and the content stream is encoded using the second bitrate.

In an embodiment, the determining the second bitrate comprises changing the first bitrate by a maximum allowable bitrate change.

It should be appreciated that many other features, applications, embodiments, and/or variations of the disclosed technology will be apparent from the accompanying drawings and from the following detailed description. Additional and/or alternative implementations of the structures, systems, non-transitory computer readable media, and methods described herein can be employed without departing from the principles of the disclosed technology.

### BRIEF DESCRIPTION OF THE DRAWINGS

FIG. 1 illustrates an example system including a video transmission module, according to an embodiment of the present disclosure.

FIG. 2 illustrates an example device-side bitrate determination module, according to an embodiment of the present disclosure.

FIG. 3 illustrates an example scenario associated with a sudden increase in device movement and a gradual increase in bitrate, according to an embodiment of the present disclosure.

FIG. 4 illustrates an example server-side bitrate determination module, according to an embodiment of the present disclosure.

FIG. 5A illustrates an example method associated with determining a content stream bitrate based on device motion metrics, according to an embodiment of the present disclosure.

FIG. 5B illustrates an example method associated with providing a server-side bitrate recommendation to a broadcasting user's computing device, according to an embodiment of the present disclosure.

FIG. 6 illustrates a network diagram of an example system including an example social networking system that can be utilized in various scenarios, according to an embodiment of the present disclosure.

FIG. 7 illustrates an example of a computer system or computing device that can be utilized in various scenarios, according to an embodiment of the present disclosure.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

### Systems and Methods for Adjusting Video Transmission Bitrates

Today, people often utilize computing devices (or systems) for a wide variety of purposes. Users can use their computing devices, for example, to interact with one another, create content, share content, and view content. For example, users can stream content through their computing devices. In general, content can be streamed from a broadcasting user's computing device, which uploads encoded data (e.g., audio, video, or both). The encoded data then can be downloaded, decoded, and presented on a viewing user's computing device.

Under conventional approaches, content may be broadcast through a content provider (e.g., social networking system) using various broadcast media (e.g., Internet broadcasting, etc.). In one example, a live content stream can include content that is being captured and streamed live by a broadcasting user. For example, the broadcasting user can capture and stream video content (e.g., a live video of the broadcasting user, concert, speech, etc.) as part of a live content stream. Video content can be captured using computing devices (e.g., mobile devices with audio and video capture capabilities) and/or standalone devices (e.g., video cameras and microphones). When a broadcasting user transmits a live content stream to the content provider, the broadcasting user's computing device encodes and provides the live content stream to the content provider over a network (e.g., the Internet) in real-time. A viewing user operating a computing device can access the live content stream through the content provider. The viewing user's computing device can decode and present the live content stream, for example, through a display screen of the viewing user's computing device.

When a broadcasting user broadcasts a live content stream to a content provider, data is transmitted from the broadcasting user's computing device to the content provider. As video capture capabilities on computing devices (e.g., mobile devices) improve, the amount of data being captured and transmitted can be very large. The potentially large amount of data being transmitted can be an important consideration given that broadcasting users may be broadcasting content using a cellular connection. As such, large amounts of data transmitted by a broadcasting user's computing device may cause the user to exceed data transmission limits imposed by cellular service carriers, which can result in exorbitantly large data overage charges. However, decreasing the amount of data transmitted by a broadcasting user's computing device may result in lower video quality, which is also an undesirable outcome. As such, there is tension between the competing goals of broadcasting high quality live content streams and minimizing the amount of data being transmitted by a broadcasting user's computing device. Accordingly, conventional approaches may not be effective in addressing these and other problems arising in computer technology.

An improved approach rooted in computer technology overcomes the foregoing and other disadvantages associated with conventional approaches specifically arising in the realm of computer technology. In general, video content that is relatively static can be encoded at a lower bitrate while maintaining a relatively high level of visual quality. Conversely, video content that captures a large amount of motion or action may require a relatively higher bitrate in order to maintain the same level of visual quality. For example, a content stream, such as a live content stream, depicting a peaceful forest with relatively little movement can be presented with high visual quality even when encoded with a low bitrate. Conversely, a content stream of a football game requires a higher bitrate in order to be presented with the same level of visual quality. In various embodiments of the present disclosure, the amount of motion or action being depicted by a live content stream can be approximated or predicted based on the amount of motion or movement of a broadcasting user's computing device while the live content stream is being captured. For example, if the broadcasting user's computing device is perfectly still during capture of the live content stream, this may be indicative of a live content stream that depicts a relatively peaceful event. Conversely, if the broadcasting user's computing device is shaking and constantly moving during capture of the live content stream, this may be indicative of the live content stream depicting very active content. As such, in various embodiments of the present disclosure, the movement of a broadcasting user's computing device is used to inform a determination of the bitrate at which a live content stream is encoded. In certain embodiments, one or more motion sensors (e.g., a gyroscope or accelerometer) in a broadcasting user's computing device can be used to measure motion metrics (e.g., speed, velocity, acceleration, etc.) for the broadcasting user's computing device as it captures video content for a live content stream. As the live content stream is being captured and encoded, the bitrate at which the live content stream is encoded can be informed by the motion metrics. For example, motion metrics indicative of a higher degree of device movement may result in a higher bitrate, whereas motion metrics indicative of a lower degree of device movement may result in a lower bitrate. The bitrate for a live content stream can be periodically updated based on the motion metrics. For example, a live content stream may start out with minimal device movement, resulting in a relatively low bitrate. As the live content stream progresses, the broadcasting user's device may begin to move more and more, causing the bitrate to gradually increase. Additional examples and embodiments will be described in greater detail herein.

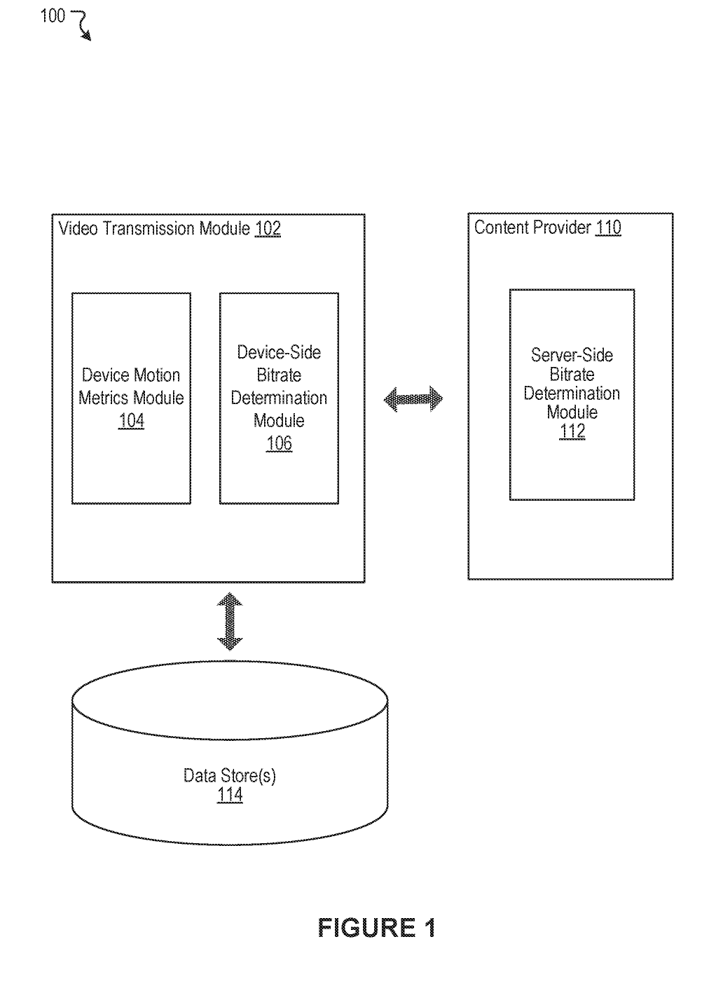

FIG. 1 illustrates an example system 100 including an example video transmission module 102 configured to encode and transmit a content stream, such as a live (e.g., real time, near real time) content stream, captured by a computing device of a broadcasting user, according to an embodiment of the present disclosure. In the example system 100 shown in FIG. 1, the video transmission module 102 is configured to communicate with a content provider 110. In various embodiments, the video transmission module 102 can be configured to encode a live content stream, and to transmit the encoded live content stream to the content provider 110. The live content stream can then be accessed by one or more viewing users via the content provider 110. In an alternative embodiment, the encoded live content stream can be transmitted directly to computing devices of the one or more viewing users. This may be the case, for example, if two users are video conferencing with one another.

In certain embodiments, a live content stream is encoded at a particular bitrate. The bitrate at which a live content stream is encoded can vary over time. For example, a first portion of the live content stream can be encoded at a first bitrate, a second portion of the live content stream can be encoded at a second bitrate, a third portion of the live content stream can be encoded at a third bitrate, and so forth. In certain embodiments, the bitrate at which a live content stream is encoded can be determined and/or varied based on various bitrate criteria. In one embodiment, the bitrate criteria can include motion metrics. Motion sensors in a broadcasting user's computing device can be used to obtain the motion metrics for the computing device. Motion metrics in relation to the computing device can include, for example, speed, velocity, acceleration, angular speed, angular velocity, angular acceleration, distance traveled, etc. Motion metrics can be used to inform a determination of the bitrate at which a live video stream is encoded. For example, motion metrics indicative of a relatively high degree of movement can correspond to a relatively high bitrate, while motion metrics indicative of a relatively low degree of movement can correspond to a relatively low bitrate. In another example, motion metrics indicative of a decreasing degree of movement can result in a decrease in bitrate, and motion metrics indicative of an increasing degree of movement can result in an increase in bitrate. In yet another example, degree of movement of the computing device can be linearly or non-linearly proportional or correlated to bitrate. Various additional embodiments, as well as additional bitrate criteria, will be discussed in greater detail herein.

As shown in the example of FIG. 1, the video transmission module 102 can include a device motion metrics module 104 and a device-side bitrate determination module 106. In some instances, the example system 100 can include at least one data store 114. In various embodiments, the example system 100 can also include a content provider 110 comprising a server-side bitrate determination module 112. The components (e.g., modules, elements, etc.) shown in this figure and all figures herein are exemplary only, and other implementations may include additional, fewer, integrated, or different components. Some components may not be shown so as not to obscure relevant details.

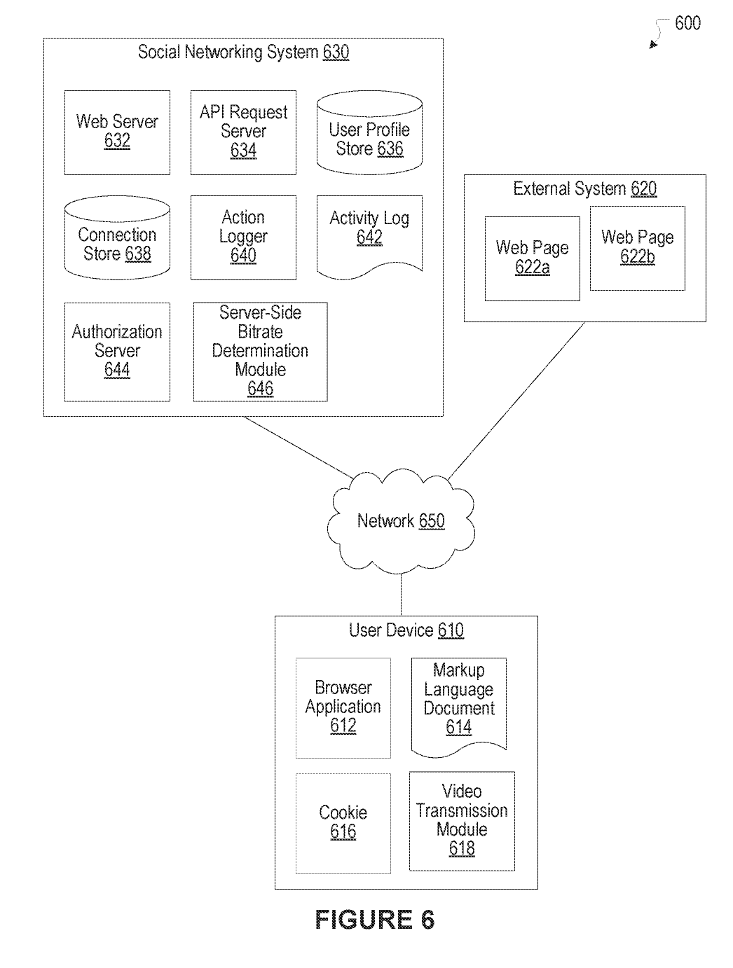

The video transmission module 102 can be implemented, in part or in whole, as software, hardware, or any combination thereof. In general, a module as discussed herein can be associated with software, hardware, or any combination thereof. In some implementations, one or more functions, tasks, and/or operations of modules can be carried out or performed by software routines, software processes, hardware, and/or any combination thereof. In some cases, the video transmission module 102 can be implemented, in part or in whole, as software running on one or more computing devices or systems, such as on a server computing system or a user (or client) computing system. For example, the video transmission module 102 or at least a portion thereof can be implemented as or within an application (e.g., app), a program, or an applet, etc., running on a user computing device or a client computing system, such as the user device 610 of FIG. 6. In another example, the video transmission module 102 or at least a portion thereof can be implemented using one or more computing devices or systems that include one or more servers, such as network servers or cloud servers. In some instances, the video transmission module 102 can, in part or in whole, be implemented within or configured to operate in conjunction with a social networking system (or service), such as the social networking system 630 of FIG. 6. It should be understood that there can be many variations or other possibilities.

The video transmission module 102 can be configured to communicate and/or operate with the at least one data store 114, as shown in the example system 100. The data store 114 can be configured to store and maintain various types of data. In some implementations, the data store 114 can store information associated with the social networking system (e.g., the social networking system 630 of FIG. 6). The information associated with the social networking system can include data about users, user identifiers, social connections, social interactions, profile information, demographic information, locations, geo-fenced areas, maps, places, events, pages, groups, posts, communications, content, feeds, account settings, privacy settings, a social graph, and various other types of data. In some embodiments, the data store 114 can store information that is utilized by the video transmission module 102. For example, the data store 114 can store live content streams, device-side bitrate criteria, server-side bitrate criteria, device motion metrics, bitrate calculation algorithms, one or more machine learning models, real-time user feedback, and the like, as described in greater detail herein. It is contemplated that there can be many variations or other possibilities. For example, in certain embodiments, the content provider 110 or the server-side bitrate determination module 112 can be configured to communicate and/or operate with a separate data store that can maintain information similar to the information maintained by the at least one data store 114.

The device motion metrics module 104 can be configured to measure motion metrics for a broadcasting user's computing device, according to an embodiment of the present disclosure. Motion metrics can include any measurement indicative of a degree and/or nature of movement by a broadcasting user's computing device. Motion metrics can include, for example, speed, velocity, acceleration, angular (or radial) speed, angular velocity, angular acceleration, linear distance traveled, angular distance traveled, etc. Motion metrics can be measured using one or more motion sensors. Motion sensors can include, for example, a gyroscope and/or an accelerometer in the broadcasting user's computing device.

The device-side bitrate determination module 106 can be configured to determine bitrates for encoding a content stream (e.g., a live content stream) based on device-side bitrate criteria, according to an embodiment of the present disclosure. As video content for a live content stream is captured, it is encoded at a particular bitrate and then transmitted or uploaded for viewing by other users. In certain embodiments, the bitrate may be selected from a range of bitrates, including a minimum bitrate and a maximum bitrate. For example, the minimum bitrate can be 256 kbps, and the maximum bitrate can be 1 Mbps. Many other bitrates are possible. The bitrate with which a live content stream is encoded can vary over time. For example, as a live content stream is being captured and broadcast, the bitrate at which it is being encoded can be updated periodically (e.g., every second, every two seconds, etc.). The bitrate for a given segment of the live content stream can be determined based on various device-side bitrate criteria.

In certain embodiments, the device-side bitrate criteria can include motion metrics such that the bitrate is determined based on motion metrics. The motion metrics can be measured by, for example, the device motion metrics module 104. Motion metrics can be utilized to determine a nature and/or degree of movement for a broadcasting user's device, and bitrate can be determined and/or varied based on the motion metrics. For example, motion metrics indicative of a higher degree of device movement can result in a higher or increased bitrate, while motion metrics indicative of a lower degree of device movement can result in a lower or decreased bitrate.

In certain embodiments, device-side bitrate criteria can include additional criteria, such as camera-based criteria. For example, a broadcasting user's computing device may comprise multiple cameras (e.g., a front-facing camera and a rear-facing camera), and selection of a particular camera can affect the bitrate. The device-side bitrate determination module 106 is described in greater detail herein.

As shown in FIG. 1, in various embodiments, the video transmission module 102 can communicate with a content provider 110 for broadcasting of content streams. For example, the content provider 110 can be a social networking system, such that a broadcasting user can upload a live content stream to the social networking system, and other users of the social networking system can view the live content stream. The content provider 110 can include a server-side bitrate determination module 112. The server-side bitrate determination module 112 can be configured to determine a bitrate recommendation based on server-side bitrate criteria. In certain embodiments, as a broadcasting user captures a live content stream, each segment of the live content stream is encoded with a particular bitrate and then transmitted to the content provider 110. The content provider 110 can perform its own analysis of the live content stream to determine whether or not the bitrate(s) being used are optimal. For example, the server-side bitrate determination module 112 can determine a bitrate recommendation based on server-side bitrate criteria that are different from the device-side bitrate criteria. The bitrate recommendation can include, for example, a recommended bitrate (i.e., a bitrate value that is determined by the server-side bitrate determination module 112), or a recommendation to increase or decrease the bitrate. The bitrate recommendation can be provided to a broadcasting user's computing device to inform a determination of the bitrate used to encode subsequent portions of the live content stream. As such, in certain embodiments, the device-side bitrate criteria utilized by the device-side bitrate determination module 106 can include consideration of a server-side bitrate recommendation.

A bitrate recommendation from the server-side bitrate determination module 112 may be useful for various reasons. For example, the content provider 110 may have access to greater computing power and resources than a broadcasting user's computing device. Consider an example scenario in which the broadcasting user's computing device is a mobile phone, and the content provider 110 is a social networking system with access to multiple servers that can perform more resource-intensive computing tasks. The server-side bitrate determination module 112 may be in position to utilize greater computing resources to perform more comprehensive analysis of the live content stream. As such, the server-side bitrate determination module 112 may be able to make a bitrate recommendation that is better informed than a bitrate calculated by the device-side bitrate determination module 106.

In certain embodiments, server-side bitrate criteria can include machine learning model criteria, in which one or more machine learning models are used to inform a bitrate recommendation determination. In certain embodiments, server-side bitrate criteria can include user feedback criteria, in which real-time user feedback about video quality is used to inform the bitrate recommendation determination. The server-side bitrate determination module 112 is described in greater detail herein.

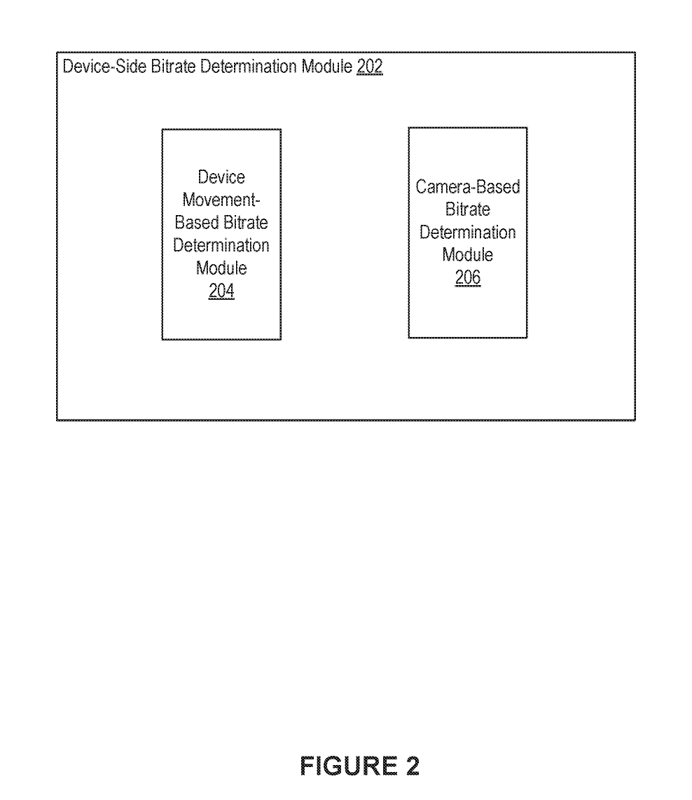

FIG. 2 illustrates an example device-side bitrate determination module 202 configured to determine bitrates for a content stream (e.g., a live content stream) based on device-side bitrate criteria, according to an embodiment of the present disclosure. In some embodiments, the device-side bitrate determination module 106 of FIG. 1 can be implemented as the example device-side bitrate determination module 202. As shown in FIG. 2, the device-side bitrate determination module 202 can include a device movement-based bitrate determination module 204 and a camera-based bitrate determination module 206.

The device movement-based bitrate determination module 204 can be configured to inform a device-side bitrate determination based on device motion metrics. As discussed above, motion metrics can be captured by one or more motion sensors and can be indicative of a nature and/or degree of movement of a broadcasting user's computing device. In certain embodiments, a relatively low degree of device movement can result in a lower bitrate, whereas a relatively high degree of device movement can result in a higher bitrate.

In certain embodiments, one or more motion metrics can be combined to calculate a movement score. For example, a movement score may be based on a single motion metric (e.g., device acceleration), or the movement score may be a combination of multiple motion metrics (e.g., device speed, device acceleration, device angular acceleration, etc.). In certain embodiments, a range of movement scores can be mapped to a range of possible bitrates, such that each movement score in the range of movement scores corresponds to a particular bitrate in the range of possible bitrates. For example, movement scores at or below a lower movement score threshold (indicative of a low amount of device movement) can correspond to a minimum bitrate, movement scores at or above an upper movement score threshold (indicative of a higher amount of device movement) can correspond to a maximum bitrate, and movement scores between the lower and upper movement score thresholds can correspond to bitrates between the minimum and maximum bitrates.

In certain embodiments, motion metrics can be utilized to determine a particular action being taken by a broadcasting user. For example, motion metrics can be utilized to determine whether a broadcasting user is walking, speed-walking, running, jumping, driving, etc. A particular action can correspond to a particular bitrate, or a range of bitrates. For example, walking may correspond to a lower bitrate or a lower range of bitrates than running. As such, bitrates can be determined and/or varied based on an action that the broadcasting user is determined to be taking.

In certain embodiments, it may be desirable to avoid drastic, sudden fluctuations in bitrate. As such, a maximum allowable bitrate change can be defined. As discussed above, bitrates for a live content stream may be modified periodically, e.g., every second. As such, a live content stream can be divided into segments. At the end of each segment, the bitrate can be updated based on updated bitrate criteria, e.g., updated motion metrics. The degree to which the bitrate can change from one segment to another can be capped by the maximum allowable bitrate change. For example, it may be determined that bitrate cannot change by more than 50 kbps from one segment to another. As such, even if the amount of device movement increases or decreases dramatically, the bitrate will change somewhat gradually so as to prevent sudden fluctuations in bitrate.

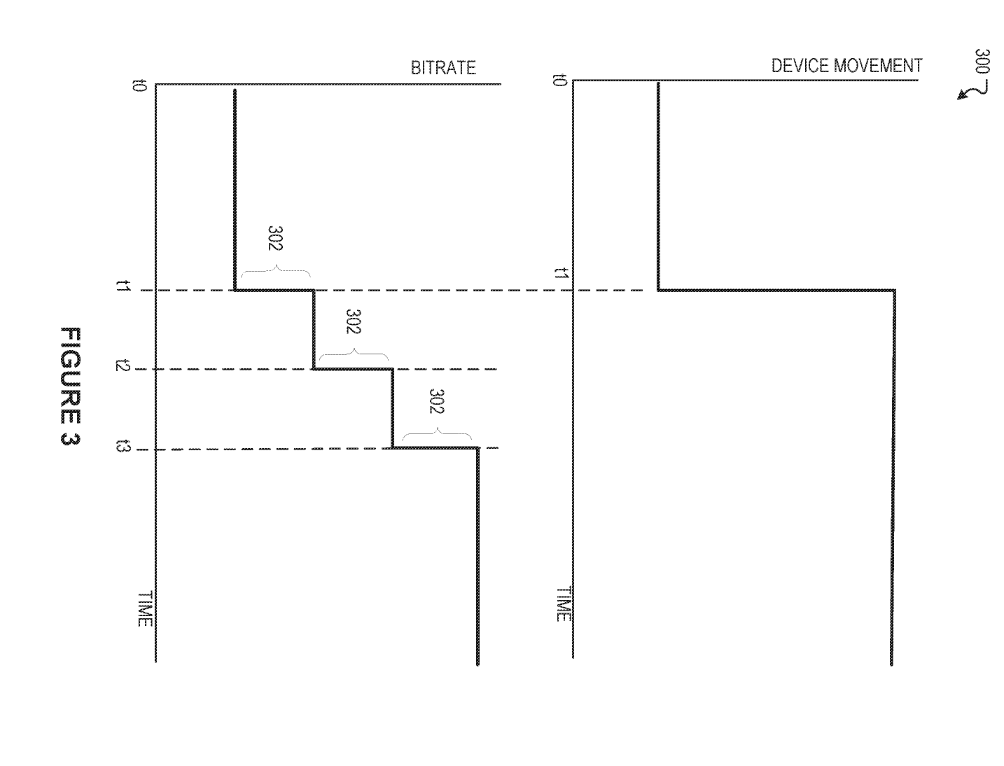

Consider the example scenario 300 depicted in FIG. 3. The example scenario 300 of FIG. 3 is associated with a sudden increase in device movement and a gradual increase in bitrate. As can be seen in the upper graph of example scenario 300, a broadcasting user's computing device begins at a relatively low level of movement at a time t0. The degree of device movement remains substantially constant until a time t1, at which time the degree of device movement suddenly increases to a high level of movement. The lower graph of example scenario 300 represents the bitrate for a live content stream being captured by the computing device. From time t0 to time t1, the bitrate is relatively low based on the low degree of device movement during that time. At time t1, the degree of device movement increases dramatically. The increased level of device movement corresponds to a significantly higher bitrate. However, the increase in bitrate is capped by a maximum allowable bitrate change 302. As such, at the end of each segment (t2, t3), the bitrate can only increase by the maximum allowable bitrate change 302, resulting in a more gradual bitrate increase. The bitrate gradually increases by the maximum amount allowable until the bitrate reaches the bitrate that corresponds to the higher degree of device movement.

In certain embodiments, gradual fluctuations in bitrate may be implemented by utilizing past motion metrics and/or past bitrates in determining a current bitrate. For example, consider an example scenario in which during a first segment, motion metrics indicate little to no movement by a broadcasting user's computing device, resulting in a low bitrate. In a second segment, motion metrics may indicate a sudden increase in device movement, which would result in a spike in bitrate. To prevent this sudden increase in bitrate, the bitrate determination for the second segment can take into consideration motion metrics for the first segment, e.g., by averaging the motion metrics for the first and second segments, resulting in a more gradual increase in bitrate.

Returning to FIG. 2, the camera-based bitrate determination module 206 can be configured to inform a device-side bitrate determination based on a camera selection by a broadcasting user. In certain embodiments, a broadcasting user's computing device used to capture a live content stream may include multiple cameras. For example, the computing device may include a front-facing camera (e.g., a selfie camera), and a rear-facing camera. In certain embodiments, selection of the rear-facing camera may indicate that the broadcasting user is filming a scene that the broadcasting user is witnessing, whereas selection of the front-facing camera may indicate that the broadcasting user is filming himself or herself. In other words, selection of the front-facing camera may indicate a high likelihood that the broadcasting user is filming himself or herself talking or looking into the camera, which typically does not involve a high degree of motion or action. Selection of the rear-facing camera, therefore, may indicate a higher likelihood of capturing motion or action. As such, in various embodiments, selection of the rear-facing camera may result in a higher bitrate than selection of the front-facing camera.

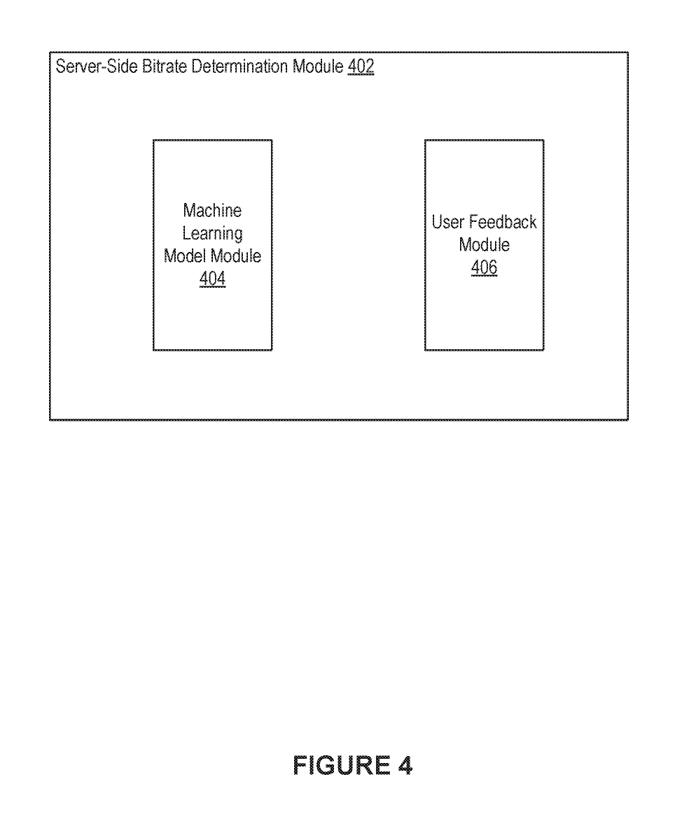

FIG. 4 illustrates an example server-side bitrate determination module 402 configured to determine bitrate recommendations for a content stream (e.g., a live content stream) based on server-side bitrate criteria, according to an embodiment of the present disclosure. In some embodiments, the server-side bitrate determination module 112 of FIG. 1 can be implemented as the example server-side bitrate determination module 402. As shown in FIG. 4, the server-side bitrate determination module 402 can include a machine learning model module 404 and a user feedback module 406.

The machine learning model module 404 can be configured to inform a server-side bitrate recommendation determination based on one or more machine learning models. As noted above, a broadcasting user's computing device may have limited computing resources. As such, computing intensive tasks, such as real-time visual analysis of the content of a live content stream may be impractical for a broadcasting user's computing device. Therefore, the degree of motion depicted in a live content stream may be approximated or predicted. For example, the degree of device movement by the broadcasting user's computing device can be used as a proxy or predictor for motion captured in the live content stream. However, a content provider with greater computing resources available may be able to perform computing resource-intensive tasks, such as real-time visual analysis.

In certain embodiments, the machine learning model module 404 can be configured to conduct a motion analysis of the content of a live content stream based on one or more machine learning models. The machine learning models can be trained to determine a level of motion depicted in the live content stream based on visual and/or audio qualities of the live content stream. A bitrate recommendation can be determined based on the amount of motion being depicted in the live content stream, as determined by the one or more machine learning models.

The bitrate recommendation can be transmitted to the broadcasting user's computing device to inform the device-side bitrate determination. For example, a broadcasting user's computing device may encode a live content stream at a very low bitrate because, for example, it has determined that the computing device is not moving at all. However, the machine learning model module 404 may determine that a higher bitrate is more appropriate because significant motion is being depicted in the live content stream. A bitrate recommendation can be transmitted from the content provider to the broadcasting user's computing device. In various embodiments, the bitrate recommendation can include a recommended bitrate (in this example scenario, a recommended bitrate that is higher than the current bitrate) and/or a recommendation to modify the bitrate (in this example scenario, a recommendation to increase the bitrate). The broadcasting user's computing device can increase the bitrate based on the bitrate recommendation. In certain embodiments, a bitrate recommendation is transmitted to the broadcasting user's computing device only if the server-side bitrate determination module 402 determines that the bitrate should be modified by more than a threshold amount. In an alternative embodiment, bitrate recommendations are regularly transmitted to the broadcasting user's computing device, e.g., at regular time intervals.

The user feedback module 406 can be configured to inform a server-side bitrate recommendation based on user feedback associated with a live content stream. Users viewing a live content stream may be given the opportunity to provide feedback as to the video quality of the live content stream. The user feedback module 406 can receive and process such feedback. If viewing users provide feedback indicative of poor video quality, the user feedback module 406 can provide a recommendation to the broadcasting user's computing device to increase the bitrate.

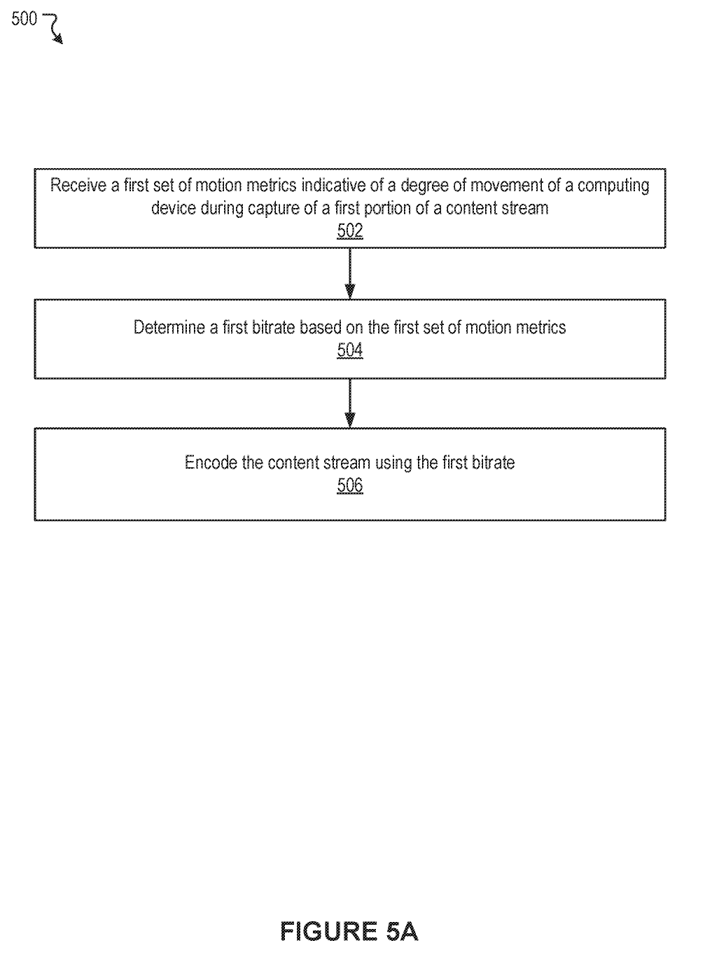

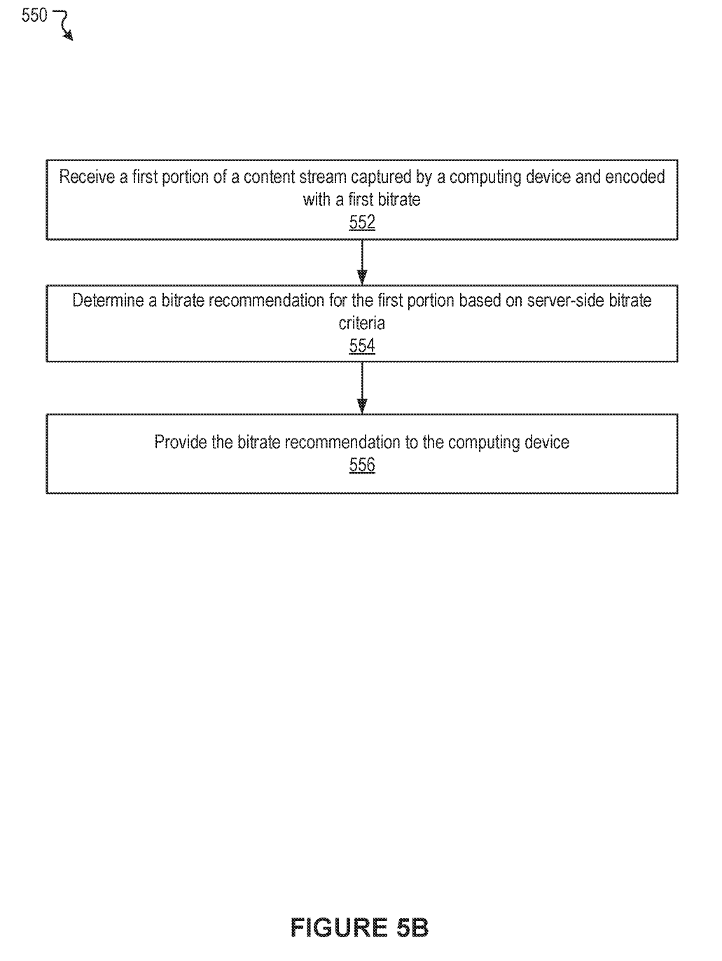

FIG. 5A illustrates an example method 500 associated with determining a content stream bitrate based on device motion metrics, according to an embodiment of the present disclosure. It should be appreciated that there can be additional, fewer, or alternative steps performed in similar or alternative orders, or in parallel, within the scope of the various embodiments discussed herein unless otherwise stated.

At block 502, the example method 500 can receive a first set of motion metrics indicative of a degree of movement of a computing device during capture of a first portion of a content stream. At block 504, the example method 500 can determine a first bitrate based on the first set of motion metrics. At block 506, the example method 500 can encode the content stream using the first bitrate.

FIG. 5B illustrates an example method 550 associated with providing a server-side bitrate recommendation to a broadcasting user's computing device, according to an embodiment of the present disclosure. It should be appreciated that there can be additional, fewer, or alternative steps performed in similar or alternative orders, or in parallel, within the scope of the various embodiments discussed herein unless otherwise stated.

At block 552, the example method 550 can receive a first portion of a content stream captured by a computing device and encoded with a first bitrate. At block 554, the example method 550 can determine a bitrate recommendation for the first portion based on sever-side bitrate criteria. At block 556, the example method 550 can provide the bitrate recommendation to the computing device.

It is contemplated that there can be many other uses, applications, and/or variations associated with the various embodiments of the present disclosure. For example, in some cases, user can choose whether or not to opt-in to utilize the disclosed technology. The disclosed technology can also ensure that various privacy settings and preferences are maintained and can prevent private information from being divulged. In another example, various embodiments of the present disclosure can learn, improve, and/or be refined over time.

### Social Networking System—Example Implementation

FIG. 6 illustrates a network diagram of an example system 600 that can be utilized in various scenarios, according to an embodiment of the present disclosure. The system 600 includes one or more user devices 610, one or more external systems 620, a social networking system (or service) 630, and a network 650. In an embodiment, the social networking service, provider, and/or system discussed in connection with the embodiments described above may be implemented as the social networking system 630. For purposes of illustration, the embodiment of the system 600, shown by FIG. 6, includes a single external system 620 and a single user device 610. However, in other embodiments, the system 600 may include more user devices 610 and/or more external systems 620. In certain embodiments, the social networking system 630 is operated by a social network provider, whereas the external systems 620 are separate from the social networking system 630 in that they may be operated by different entities. In various embodiments, however, the social networking system 630 and the external systems 620 operate in conjunction to provide social networking services to users (or members) of the social networking system 630. In this sense, the social networking system 630 provides a platform or backbone, which other systems, such as external systems 620, may use to provide social networking services and functionalities to users across the Internet.

The user device 610 comprises one or more computing devices that can receive input from a user and transmit and receive data via the network 650. In one embodiment, the user device 610 is a conventional computer system executing, for example, a Microsoft Windows compatible operating system (OS), Apple OS X, and/or a Linux distribution. In another embodiment, the user device 610 can be a device having computer functionality, such as a smart-phone, a tablet, a personal digital assistant (PDA), a mobile telephone, etc. The user device 610 is configured to communicate via the network 650. The user device 610 can execute an application, for example, a browser application that allows a user of the user device 610 to interact with the social networking system 630. In another embodiment, the user device 610 interacts with the social networking system 630 through an application programming interface (API) provided by the native operating system of the user device 610, such as iOS and ANDROID. The user device 610 is configured to communicate with the external system 620 and the social networking system 630 via the network 650, which may comprise any combination of local area and/or wide area networks, using wired and/or wireless communication systems.

In one embodiment, the network 650 uses standard communications technologies and protocols. Thus, the network 650 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 650 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 650 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 610 may display content from the external system 620 and/or from the social networking system 630 by processing a markup language document 614 received from the external system 620 and from the social networking system 630 using a browser application 612. The markup language document 614 identifies content and one or more instructions describing formatting or presentation of the content. By executing the instructions included in the markup language document 614, the browser application 612 displays the identified content using the format or presentation described by the markup language document 614. For example, the markup language document 614 includes instructions for generating and displaying a web page having multiple frames that include text and/or image data retrieved from the external system 620 and the social networking system 630. In various embodiments, the markup language document 614 comprises a data file including extensible markup language (XML) data, extensible hypertext markup language (XHTML) data, or other markup language data. Additionally, the markup language document 614 may include JavaScript Object Notation (JSON) data, JSON with padding (JSONP), and JavaScript data to facilitate data-interchange between the external system 620 and the user device 610. The browser application 612 on the user device 610 may use a JavaScript compiler to decode the markup language document 614.

The markup language document 614 may also include, or link to, applications or application frameworks such as FLASH™ or Unity™ applications, the SilverLight™ application framework, etc.

In one embodiment, the user device 610 also includes one or more cookies 616 including data indicating whether a user of the user device 610 is logged into the social networking system 630, which may enable modification of the data communicated from the social networking system 630 to the user device 610.

The external system 620 includes one or more web servers that include one or more web pages 622a, 622b, which are communicated to the user device 610 using the network 650. The external system 620 is separate from the social networking system 630. For example, the external system 620 is associated with a first domain, while the social networking system 630 is associated with a separate social networking domain. Web pages 622a, 622b, included in the external system 620, comprise markup language documents 614 identifying content and including instructions specifying formatting or presentation of the identified content.

The social networking system 630 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 630 may be administered, managed, or controlled by an operator. The operator of the social networking system 630 may be a human being, an automated application, or a series of applications for managing content, regulating policies, and collecting usage metrics within the social networking system 630. Any type of operator may be used.

Users may join the social networking system 630 and then add connections to any number of other users of the social networking system 630 to whom they desire to be connected. As used herein, the term “friend” refers to any other user of the social networking system 630 to whom a user has formed a connection, association, or relationship via the social networking system 630. For example, in an embodiment, if users in the social networking system 630 are represented as nodes in the social graph, the term “friend” can refer to an edge formed between and directly connecting two user nodes.

Connections may be added explicitly by a user or may be automatically created by the social networking system 630 based on common characteristics of the users (e.g., users who are alumni of the same educational institution). For example, a first user specifically selects a particular other user to be a friend. Connections in the social networking system 630 are usually in both directions, but need not be, so the terms “user” and “friend” depend on the frame of reference. Connections between users of the social networking system 630 are usually bilateral (“two-way”), or “mutual,” but connections may also be unilateral, or “one-way.” For example, if Bob and Joe are both users of the social networking system 630 and connected to each other, Bob and Joe are each other's connections. If, on the other hand, Bob wishes to connect to Joe to view data communicated to the social networking system 630 by Joe, but Joe does not wish to form a mutual connection, a unilateral connection may be established. The connection between users may be a direct connection; however, some embodiments of the social networking system 630 allow the connection to be indirect via one or more levels of connections or degrees of separation.

In addition to establishing and maintaining connections between users and allowing interactions between users, the social networking system 630 provides users with the ability to take actions on various types of items supported by the social networking system 630. These items may include groups or networks (i.e., social networks of people, entities, and concepts) to which users of the social networking system 630 may belong, events or calendar entries in which a user might be interested, computer-based applications that a user may use via the social networking system 630, transactions that allow users to buy or sell items via services provided by or through the social networking system 630, and interactions with advertisements that a user may perform on or off the social networking system 630. These are just a few examples of the items upon which a user may act on the social networking system 630, and many others are possible. A user may interact with anything that is capable of being represented in the social networking system 630 or in the external system 620, separate from the social networking system 630, or coupled to the social networking system 630 via the network 650.

The social networking system 630 is also capable of linking a variety of entities. For example, the social networking system 630 enables users to interact with each other as well as external systems 620 or other entities through an API, a web service, or other communication channels. The social networking system 630 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 630. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 630 modifies edges connecting the various nodes to reflect the relationships and interactions.

The social networking system 630 also includes user-generated content, which enhances a user's interactions with the social networking system 630. User-generated content may include anything a user can add, upload, send, or “post” to the social networking system 630. For example, a user communicates posts to the social networking system 630 from a user device 610. Posts may include data such as status updates or other textual data, location information, images such as photos, videos, links, music or other similar data and/or media. Content may also be added to the social networking system 630 by a third party. Content “items” are represented as objects in the social networking system 630. In this way, users of the social networking system 630 are encouraged to communicate with each other by posting text and content items of various types of media through various communication channels. Such communication increases the interaction of users with each other and increases the frequency with which users interact with the social networking system 630.

The social networking system 630 includes a web server 632, an API request server 634, a user profile store 636, a connection store 638, an action logger 640, an activity log 642, and an authorization server 644. In an embodiment of the invention, the social networking system 630 may include additional, fewer, or different components for various applications. Other components, such as network interfaces, security mechanisms, load balancers, failover servers, management and network operations consoles, and the like are not shown so as to not obscure the details of the system.

The user profile store 636 maintains information about user accounts, including biographic, demographic, and other types of descriptive information, such as work experience, educational history, hobbies or preferences, location, and the like that has been declared by users or inferred by the social networking system 630. This information is stored in the user profile store 636 such that each user is uniquely identified. The social networking system 630 also stores data describing one or more connections between different users in the connection store 638. The connection information may indicate users who have similar or common work experience, group memberships, hobbies, or educational history. Additionally, the social networking system 630 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 630, such as non-person entities, buckets, cluster centers, images, interests, pages, external systems, concepts, and the like are also stored in the connection store 638.

The social networking system 630 maintains data about objects with which a user may interact. To maintain this data, the user profile store 636 and the connection store 638 store instances of the corresponding type of objects maintained by the social networking system 630. Each object type has information fields that are suitable for storing information appropriate to the type of object. For example, the user profile store 636 contains data structures with fields suitable for describing a user's account and information related to a user's account. When a new object of a particular type is created, the social networking system 630 initializes a new data structure of the corresponding type, assigns a unique object identifier to it, and begins to add data to the object as needed. This might occur, for example, when a user becomes a user of the social networking system 630, the social networking system 630 generates a new instance of a user profile in the user profile store 636, assigns a unique identifier to the user account, and begins to populate the fields of the user account with information provided by the user.

The connection store 638 includes data structures suitable for describing a user's connections to other users, connections to external systems 620 or connections to other entities. The connection store 638 may also associate a connection type with a user's connections, which may be used in conjunction with the user's privacy setting to regulate access to information about the user. In an embodiment of the invention, the user profile store 636 and the connection store 638 may be implemented as a federated database.

Data stored in the connection store 638, the user profile store 636, and the activity log 642 enables the social networking system 630 to generate the social graph that uses nodes to identify various objects and edges connecting nodes to identify relationships between different objects. For example, if a first user establishes a connection with a second user in the social networking system 630, user accounts of the first user and the second user from the user profile store 636 may act as nodes in the social graph. The connection between the first user and the second user stored by the connection store 638 is an edge between the nodes associated with the first user and the second user. Continuing this example, the second user may then send the first user a message within the social networking system 630. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 630 (or, alternatively, in an image maintained by another system outside of the social networking system 630). The image may itself be represented as a node in the social networking system 630. This tagging action may create edges between the first user and the second user as well as create an edge between each of the users and the image, which is also a node in the social graph. In yet another example, if a user confirms attending an event, the user and the event are nodes obtained from the user profile store 636, where the attendance of the event is an edge between the nodes that may be retrieved from the activity log 642. By generating and maintaining the social graph, the social networking system 630 includes data describing many different types of objects and the interactions and connections among those objects, providing a rich source of socially relevant information.

The web server 632 links the social networking system 630 to one or more user devices 610 and/or one or more external systems 620 via the network 650. The web server 632 serves web pages, as well as other web-related content, such as Java, JavaScript, Flash, XML, and so forth. The web server 632 may include a mail server or other messaging functionality for receiving and routing messages between the social networking system 630 and one or more user devices 610. The messages can be instant messages, queued messages (e.g., email), text and SMS messages, or any other suitable messaging format.

The API request server 634 allows one or more external systems 620 and user devices 610 to call access information from the social networking system 630 by calling one or more API functions. The API request server 634 may also allow external systems 620 to send information to the social networking system 630 by calling APIs. The external system 620, in one embodiment, sends an API request to the social networking system 630 via the network 650, and the API request server 634 receives the API request. The API request server 634 processes the request by calling an API associated with the API request to generate an appropriate response, which the API request server 634 communicates to the external system 620 via the network 650. For example, responsive to an API request, the API request server 634 collects data associated with a user, such as the user's connections that have logged into the external system 620, and communicates the collected data to the external system 620. In another embodiment, the user device 610 communicates with the social networking system 630 via APIs in the same manner as external systems 620.

The action logger 640 is capable of receiving communications from the web server 632 about user actions on and/or off the social networking system 630. The action logger 640 populates the activity log 642 with information about user actions, enabling the social networking system 630 to discover various actions taken by its users within the social networking system 630 and outside of the social networking system 630. Any action that a particular user takes with respect to another node on the social networking system 630 may be associated with each user's account, through information maintained in the activity log 642 or in a similar database or other data repository. Examples of actions taken by a user within the social networking system 630 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 630, the action is recorded in the activity log 642. In one embodiment, the social networking system 630 maintains the activity log 642 as a database of entries. When an action is taken within the social networking system 630, an entry for the action is added to the activity log 642. The activity log 642 may be referred to as an action log.

Additionally, user actions may be associated with concepts and actions that occur within an entity outside of the social networking system 630, such as an external system 620 that is separate from the social networking system 630. For example, the action logger 640 may receive data describing a user's interaction with an external system 620 from the web server 632. In this example, the external system 620 reports a user's interaction according to structured actions and objects in the social graph.

Other examples of actions where a user interacts with an external system 620 include a user expressing an interest in an external system 620 or another entity, a user posting a comment to the social networking system 630 that discusses an external system 620 or a web page 622a within the external system 620, a user posting to the social networking system 630 a Uniform Resource Locator (URL) or other identifier associated with an external system 620, a user attending an event associated with an external system 620, or any other action by a user that is related to an external system 620. Thus, the activity log 642 may include actions describing interactions between a user of the social networking system 630 and an external system 620 that is separate from the social networking system 630.

The authorization server 644 enforces one or more privacy settings of the users of the social networking system 630. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 620, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 620. One embodiment allows the specification of the set of entities to comprise an enumeration of entities. For example, the user may provide a list of external systems 620 that are allowed to access certain information. Another embodiment allows the specification to comprise a set of entities along with exceptions that are not allowed to access the information. For example, a user may allow all external systems 620 to access the user's work information, but specify a list of external systems 620 that are not allowed to access the work information. Certain embodiments call the list of exceptions that are not allowed to access certain information a “block list”. External systems 620 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 644 contains logic to determine if certain information associated with a user can be accessed by a user's friends, external systems 620, and/or other applications and entities. The external system 620 may need authorization from the authorization server 644 to access the user's more private and sensitive information, such as the user's work phone number. Based on the user's privacy settings, the authorization server 644 determines if another user, the external system 620, an application, or another entity is allowed to access information associated with the user, including information about actions taken by the user.

In some embodiments, the user device 610 can include a video transmission module 618. The video transmission module 618 can, for example, be implemented as the video transmission module 102, as discussed in more detail herein. In some embodiments, the social networking system 630 can include a server-side bitrate determination module 646. The server-side bitrate determination module 646 can, for example, be implemented as the server-side bitrate determination module 112, as discussed in more detail herein. As discussed previously, it should be appreciated that there can be many variations or other possibilities. For example, in some embodiments, one or more functionalities of the video transmission module 618 can be implemented in the social networking system 630 and/or the external system 620, and one or more functionalities of the server-side bitrate determination module 646 can be implemented in the user device 610 and/or the external system 620.

### Hardware Implementation

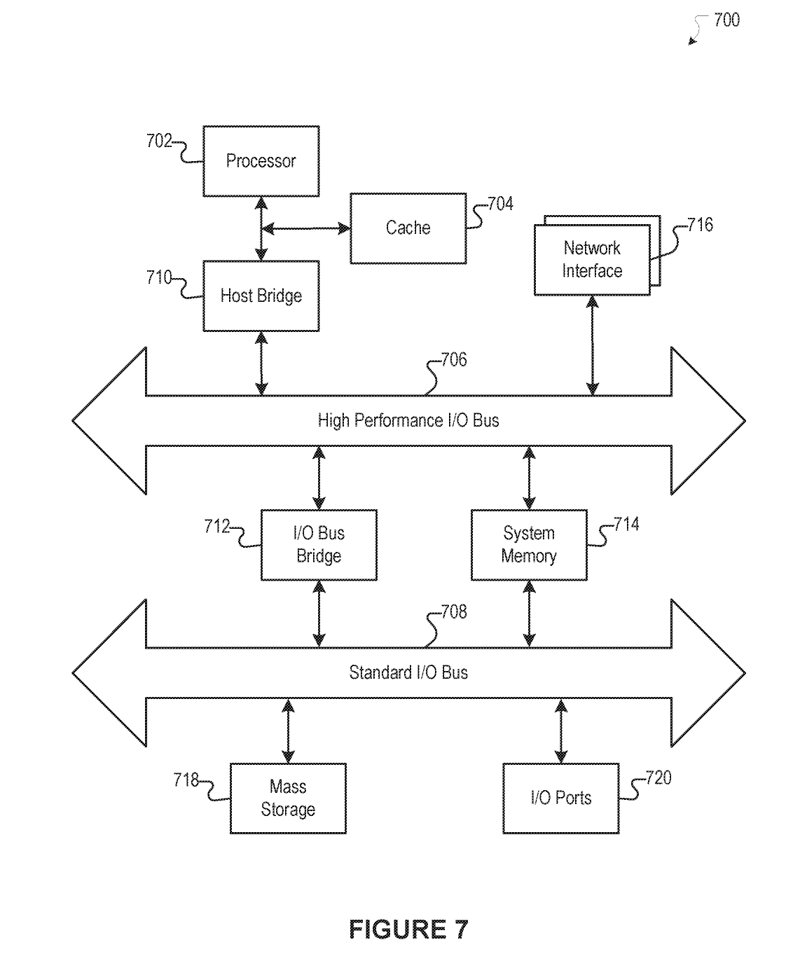

The foregoing processes and features can be implemented by a wide variety of machine and computer system architectures and in a wide variety of network and computing environments. FIG. 7 illustrates an example of a computer system 700 that may be used to implement one or more of the embodiments described herein according to an embodiment of the invention. The computer system 700 includes sets of instructions for causing the computer system 700 to perform the processes and features discussed herein. The computer system 700 may be connected (e.g., networked) to other machines. In a networked deployment, the computer system 700 may operate in the capacity of a server machine or a client machine in a client-server network environment, or as a peer machine in a peer-to-peer (or distributed) network environment. In an embodiment of the invention, the computer system 700 may be the social networking system 630, the user device 610, and the external system 620, or a component thereof. In an embodiment of the invention, the computer system 700 may be one server among many that constitutes all or part of the social networking system 630.

The computer system 700 includes a processor 702, a cache 704, and one or more executable modules and drivers, stored on a computer-readable medium, directed to the processes and features described herein. Additionally, the computer system 700 includes a high performance input/output (I/O) bus 706 and a standard I/O bus 708. A host bridge 710 couples processor 702 to high performance I/O bus 706, whereas I/O bus bridge 712 couples the two buses 706 and 708 to each other. A system memory 714 and one or more network interfaces 716 couple to high performance I/O bus 706. The computer system 700 may further include video memory and a display device coupled to the video memory (not shown). Mass storage 718 and I/O ports 720 couple to the standard I/O bus 708. The computer system 700 may optionally include a keyboard and pointing device, a display device, or other input/output devices (not shown) coupled to the standard I/O bus 708. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 700, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 700 are described in greater detail below. In particular, the network interface 716 provides communication between the computer system 700 and any of a wide range of networks, such as an Ethernet (e.g., IEEE 802.3) network, a backplane, etc. The mass storage 718 provides permanent storage for the data and programming instructions to perform the above-described processes and features implemented by the respective computing systems identified above, whereas the system memory 714 (e.g., DRAM) provides temporary storage for the data and programming instructions when executed by the processor 702. The I/O ports 720 may be one or more serial and/or parallel communication ports that provide communication between additional peripheral devices, which may be coupled to the computer system 700.

The computer system 700 may include a variety of system architectures, and various components of the computer system 700 may be rearranged. For example, the cache 704 may be on-chip with processor 702. Alternatively, the cache 704 and the processor 702 may be packed together as a “processor module”, with processor 702 being referred to as the “processor core”. Furthermore, certain embodiments of the invention may neither require nor include all of the above components. For example, peripheral devices coupled to the standard I/O bus 708 may couple to the high performance I/O bus 706. In addition, in some embodiments, only a single bus may exist, with the components of the computer system 700 being coupled to the single bus. Moreover, the computer system 700 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 700 that, when read and executed by one or more processors, cause the computer system 700 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 700, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 702. Initially, the series of instructions may be stored on a storage device, such as the mass storage 718. However, the series of instructions can be stored on any suitable computer readable storage medium. Furthermore, the series of instructions need not be stored locally, and could be received from a remote storage device, such as a server on a network, via the network interface 716. The instructions are copied from the storage device, such as the mass storage 718, into the system memory 714 and then accessed and executed by the processor 702. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 700 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
receiving, by a computing device, a first set of motion metrics indicative of a degree of movement of the computing device during capture of a first portion of a content stream;
determining, by the computing device, a first bitrate based on the first set of motion metrics; and
encoding, by the computing device, the content stream using the first bitrate.

2. The computer-implemented method of claim 1, wherein the first set of motion metrics comprise at least one of: device speed, device velocity, device acceleration, device angular speed, device angular velocity, device angular acceleration, or device distance traveled.

3. The computer-implemented method of claim 1, wherein at least a portion of the first set of motion metrics is measured by a gyroscope in the computing device.

4. The computer-implemented method of claim 1, wherein the first bitrate is selected from a range of possible bitrates, including a minimum bitrate and a maximum bitrate.

5. The computer-implemented method of claim 4, further comprising:
converting the first set of motion metrics to a first movement score, wherein
the determining the first bitrate based on the first set of motion metrics comprises determining the first bitrate based on the first movement score.

6. The computer-implemented method of claim 5, wherein each motion score of a set of potential motion scores corresponds to a bitrate of the range of possible bitrates.

7. The computer-implemented method of claim 6, wherein
motion scores at or below a lower motion score threshold correspond to the minimum bitrate, and
motion scores at or above an upper motion score threshold correspond to the maximum bitrate.

8. The computer-implemented method of claim 1, further comprising:
transmitting the encoded first portion to a content provider;
receiving a bitrate recommendation from the content provider;
determining a second bitrate based on the bitrate recommendation; and
encoding the content stream using the second bitrate.

9. The computer-implemented method of claim 1, further comprising:
receiving a second set of motion metrics indicative of a degree of movement of the computing device during capture of a second portion of the content stream;
determining a second bitrate based on the second set of motion metrics; and
encoding the content stream using the second bitrate.

10. The computer-implemented method of claim 9, wherein the determining the second bitrate comprises changing the first bitrate by a maximum allowable bitrate change.

11. A system comprising:
at least one processor; and
a memory storing instructions that, when executed by the at least one processor, cause the system to perform a method comprising:
receiving a first set of motion metrics indicative of a degree of movement of a computing device during capture of a first portion of a content stream;
determining a first bitrate based on the first set of motion metrics; and
encoding the content stream using the first bitrate.

12. The system of claim 11, wherein the first set of motion metrics comprise at least one of: device speed, device velocity, device acceleration, device angular speed, device angular velocity, device angular acceleration, or device distance traveled.

13. The system of claim 11, wherein at least a portion of the first set of motion metrics is measured by a gyroscope in the computing device.

14. The system of claim 11, wherein the first bitrate is selected from a range of possible bitrates, including a minimum bitrate and a maximum bitrate.

15. The system of claim 14, wherein the method further comprises:
converting the first set of motion metrics to a first movement score, wherein
the determining the first bitrate based on the first set of motion metrics comprises determining the first bitrate based on the first movement score.

16. A non-transitory computer-readable storage medium including instructions that, when executed by at least one processor of a computing system, cause the computing system to perform a method comprising:
receiving a first set of motion metrics indicative of a degree of movement of a computing device during capture of a first portion of a content stream;
determining a first bitrate based on the first set of motion metrics; and
encoding the content stream using the first bitrate.

17. The non-transitory computer-readable storage medium of claim 16, wherein the first set of motion metrics comprise at least one of: device speed, device velocity, device acceleration, device angular speed, device angular velocity, device angular acceleration, or device distance traveled.

18. The non-transitory computer-readable storage medium of claim 16, wherein at least a portion of the first set of motion metrics is measured by a gyroscope in the computing device.

19. The non-transitory computer-readable storage medium of claim 16, wherein the first bitrate is selected from a range of possible bitrates, including a minimum bitrate and a maximum bitrate.

20. The non-transitory computer-readable storage medium of claim 19, wherein the method further comprises:
converting the first set of motion metrics to a first movement score, wherein
the determining the first bitrate based on the first set of motion metrics comprises determining the first bitrate based on the first movement score.
